(19) United States
(12) Patent Application Publication
(10) Pub. No.: US 2013/0161043 A1
(43) Pub. Date: Jun. 27, 2013

(54) HAND TOOL DEVICE

(71) Applicants: Jens Blum, Filderstadt (DE); Heiko Roehm, Stuttgart (DE); Tobias Herr, Stuttgart (DE)

(72) Inventors: Jens Blum, Filderstadt (DE); Heiko Roehm, Stuttgart (DE); Tobias Herr, Stuttgart (DE)

(21) Appl. No.: 13/727,041

(22) Filed: Dec. 26, 2012

(30) Foreign Application Priority Data
Dec. 27, 2011 (DE) 10 2011 089 913.8

(51) Int. Cl. B25D 16/00

(52) U.S. Cl. CPC B25D 16/006
USPC 173/48

(57) ABSTRACT

A hand tool device includes: a striking mechanism which has a striker, a striker driving device, and a striker arresting device. In the case of a first drill rotation direction, the striker driving device is configured to propel the striker in at least a striking direction. The striker arresting device is configured to prevent the striker driving device from being operated in the case of a second drill rotation direction.

### BACKGROUND OF THE INVENTION

1. Field of the Invention

The present invention relates to a hand tool device including a striking mechanism, which has a striker and a striker driving device, and in the case of a first drill rotation direction, the striker driving device is configured to propel the striker in at least the striking direction.

2. Description of Related Art

Published European patent application document EP 1 690 642 A1 describes a hand tool device including a striking mechanism, which has a striker and a striker driving device; in the case of a first drill rotation direction, the striker driving device being configured to propel the striker in at least the striking direction.

### BRIEF SUMMARY OF THE INVENTION

The present invention provides a hand tool device including a striking mechanism, which has a striker and a striker driving device; in the case of a first drill rotation direction, the striker driving device being configured to propel the striker in at least the striking direction.

It is provided that the striking mechanism has a striker arresting device, which is provided to prevent, in particular, automatically, the striker driving device from being operated in the case of a second drill rotation direction. A “striking mechanism” is to be understood, in particular, as a device that is designed to generate a percussive pulse, and in particular, in the direction of an insertion tool. In at least a percussion drill mode, the striking mechanism preferably transmits the striking motion through a tool spindle and/or, in particular, through a tool chuck of the hand tool device, to the insertion tool, in an advantageous manner. In particular, the term “striker” is to be understood as an instrument, which is accelerated, in particular, translationally, in at least a percussion drill mode, and emits a pulse received during the acceleration as a percussive pulse in the direction of the insertion tool. A “striker driving device” is to be understood, in particular, as a unit that is designed to translate a rotational motion into a, in particular, translational striking motion.

The striker driving device preferably has an eccentric drive, a wobble bearing and/or, particularly preferably, a cam guide. In particular, “operation of the striker driving device” is to be understood as an operation, in which an energy, which, in particular, a drive unit of the handheld machine tool device supplies, is mechanically transmitted to the striker driving device. In particular, a “drill rotation direction” is to be understood as a direction of rotation, in which, in at least one working cycle, the tool chuck is rotationally propelled relative to a hand tool housing. The hand tool device is preferably designed to propel the insertion tool in a counterclockwise drill rotation direction and in a clockwise drill rotation direction in at least a drilling mode and/or, advantageously, in at least a screwing mode. A “striking direction” is to be understood as a direction, which runs parallel to an axis of rotation of the tool chuck, and which points from the striker in the direction of the tool chuck. In particular, a “striker arresting device” is to be understood as a device, which, in at least one operating state, prevents at least the operation of the striker driving device. In a mode in which the tool chuck is propelled in the second drill rotation direction, the striker arresting device preferably prevents the striker driving device from being operated. Alternatively, or in addition, the striker arresting device could prevent a switchover into the percussion drill mode if the second drill rotation direction is set, and/or prevent a switchover to the second drill rotation direction if the percussion drill mode is set. “Designed” is to be understood, in particular, as specially programmed, configured and/or equipped. In particular, the term “automatically” is to be understood to mean that in the second drill rotation direction, the striker arresting device prevents and/or, in particular, interrupts the operation of the striker driving device independently of at least an action of an operator. In this connection, the term “prevent” is to be understood to mean, in particular, that the striker arresting device prevents simultaneous operation of the striker arresting device and operation in the second drill rotation direction. The embodiment of the hand tool device according to the present invention allows a particularly small, light, and yet powerful striking mechanism to be provided, and allows damage to the striking mechanism due to improper operation to be prevented.

In a further embodiment, it is provided that the hand tool device have, in particular, a first planetary gear stage, which actuates the striker driving device in at least one operating state, which means that a compact design may be achieved in a structurally simple manner. A “planetary gear stage” is to be understood, in particular, as a gear stage including at least one planet gear, which is connected to a planet carrier, coupled to a ring gear in a radially outward direction, and coupled to a sun gear in a radially inward direction.

In addition, it is provided that the striker arresting device acts upon a ring gear of the planetary gear stage, through which particularly simple assembly and a low overall length in the striking direction are possible. A “ring gear” is to be understood, in particular, as an annular gear wheel having internal teeth.

In addition, it is provided that the striker arresting device acts upon a planet carrier of the planetary gear stage, which means that a particularly narrow design may be achieved. A “planet carrier” is to be understood, in particular, as a component of a planetary gear stage, which rotatably guides a planet gear on a circular path.

In addition, it is provided that the striker arresting device act upon a striking mechanism spindle of the striking mechanism, through which a particularly narrow design may be attained. A “striking mechanism spindle” is to be understood, in particular, as a shaft, which transmits a rotational motion of the planetary gear stage to the striker driving device. The striking mechanism spindle preferably takes the form of a hollow shaft.

Furthermore, it is provided that the striker arresting device be designed to automatically prevent actuation of the striker driving device in the case of a counterclockwise drill rotation direction, which means that in a percussion drill mode in the clockwise drill rotation direction, work may advantageously be performed, using an insertion tool that takes the form of a standardized percussion drill. In particular, a “counterclockwise drill rotation direction” is to be understood as a rotational direction of the tool chuck, in which, when viewed in the striking direction, the tool chuck rotates in a direction opposite to clockwise. A “clockwise drill rotation direction” is to be understood, in particular, as a rotational direction of the tool chuck, in which, when viewed in the striking direction, the tool chuck rotates clockwise.

In one advantageous embodiment of the present invention, it is provided that the striker arresting device be designed to arrest the striker driving device, in particular, automatically, in the case of a second drill rotation direction, which means that the operator may switch over from a clockwise drill rotation direction to a counterclockwise drill rotation direction in a user-friendly manner, without having to switch off a percussion drill mode. In particular, the term “arrest” is to be understood to mean that when the tool chuck is driven in the second drill rotation direction, the striker arresting device interrupts the operation of the striker driving device, in particular, automatically.

In one further embodiment, it is provided that the striker arresting device has a blocking device, which allows free-running in at least one operating state, through which, in the case of a counterclockwise drill rotation direction, advantageous stoppage may be achieved in a structurally simple manner. A “blocking device” is to be understood, in particular, as a device considered suitable by one skilled in the art, but preferably at least a jamming roller, a clutch mechanism, a detent, a toothed disk and/or a wrap spring. In particular, the term “free-running” is to be understood to mean that in the case of one direction of rotation of a component, in particular, of the ring gear, the blocking device allows the component to rotate with respect to other components, such as the hand tool housing; and that in the case of another direction of rotation of the component, the blocking device prevents the component from rotating with respect to the other component.

Furthermore, it is provided that the striker driving device has a cam guide, which drives the striker in at least a percussion drill mode, whereby a particularly small, light, and yet, powerful striking mechanism is provided. In particular, the need for a wobble bearing or a rocker arm may be advantageously eliminated. In particular, a “cam guide” is to be understood as a device, which, in order to generate a stroke, translates a rotational energy into a linear kinetic energy of the striker, using at least a specially shaped guide surface, along which a connecting device runs during a percussion drill mode. The striking mechanism preferably includes a striking mechanism spring, which stores the linear kinetic energy of the striker in order to generate a stroke. The specially shaped surface is preferably a surface, which limits a guide curve of the cam guide. In this connection, “to drive” is to be understood to mean, in particular, that the cam guide transmits an energy for generating a stroke, to the striker.

In addition, it is provided that the cam guide has a striker free-running region, through which a high stroke energy and an advantageously low degree of wear may be achieved in the case of a low overall length. A “striker free-running region” is to be understood, in particular, as a region of the guide curve of the cam guide, in which the connecting device is situated when the striking mechanism spring accelerates the striker in the striking direction. The striker free-running region is preferably formed to be so wide, that the connecting device may run through the striker free-running region on different paths. In at least the percussion drill mode, the striker free-running region preferably does not exert a force on the striker.

Furthermore, the present invention is directed to a hand tool having a hand tool device according to the present invention. The hand tool is preferably designed to propel the insertion tool in a screwing mode, in a drilling mode, in a screwing/drilling mode and, in particular, in a chipping mode.

### BRIEF DESCRIPTION OF THE DRAWINGS

FIG. 1 shows a section of a hand tool including a hand tool device according to the present invention.

FIG. 2 shows a partially exposed section of a striking mechanism and planetary gearing of the hand tool device from FIG. 1.

FIG. 3 shows a first sectional plane A of the striking mechanism of the hand tool device from FIG. 1.

FIG. 4 shows a second sectional plane B of the striking mechanism of the hand tool device from FIG. 1.

FIG. 5 shows a perspective view of a striking mechanism spindle of the striking mechanism of the hand tool device from FIG. 1.

FIG. 6 shows a perspective view of a striker of the striking mechanism of the hand tool device from FIG. 1.

FIG. 7 shows a sectional plane C of a first planetary gear stage and of a first striker arresting device of the hand tool device from FIG. 1.

FIG. 8 shows a sectional plane D of a control element and of a second striker arresting device of the hand tool device from FIG. 1.

FIG. 9 shows a perspective sectional view of a part of the hand tool device from FIG. 1.

FIG. 10 shows a sectional plane E of a spindle locking device of the hand tool device from FIG. 1.

FIG. 11 shows a sectional plane F of blocking devices of the spindle locking device of the hand tool device from FIG. 1.

FIG. 12 shows a sectional plane G of a second planetary gear stage of the hand tool device from FIG. 1.

FIG. 13 shows a sectional plane H of a third planetary gear stage of the hand tool device from FIG. 1.

FIG. 14 shows a sectional plane I of a fourth planetary gear stage of the hand tool device from FIG. 1.

FIG. 15 shows a schematic representation of an operating device and a safety device of the hand tool device from FIG. 1.

FIG. 16 shows an alternative exemplary embodiment of a first striker arresting device of a hand tool device according to the present invention.

FIG. 17 shows a further exemplary embodiment of a first striker arresting device of a hand tool device according to the present invention.

FIG. 18 shows an alternative exemplary embodiment of a striker engagement spring of a hand tool device according to the present invention.

FIG. 19 shows an alternative exemplary embodiment of an operating device and of a safety device of a hand tool device according to the present invention.

### DETAILED DESCRIPTION OF THE INVENTION

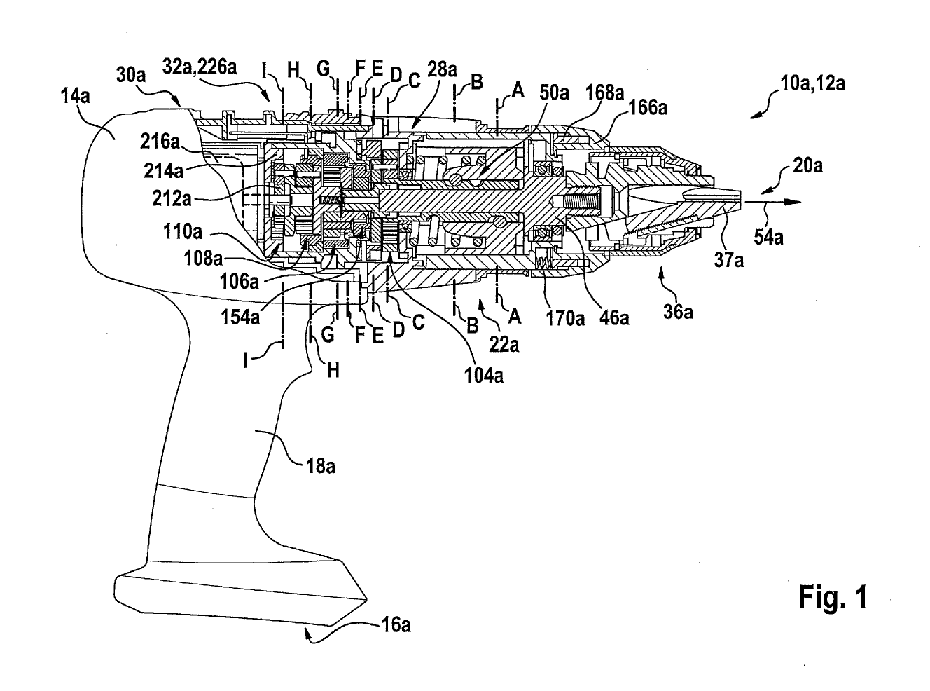

FIG. 1 shows a hand tool 10a. Hand tool 10a takes the form of an impact screwdriver. Hand tool 10a includes a hand tool device 12a of the present invention, a hand tool housing 14a and a storage battery interface 16a. Storage battery interface 16a is provided for supplying hand tool device 12a with electrical energy from a hand-tool storage battery not shown here in further detail. Hand tool housing 14a is formed in the shape of a pistol. Hand tool housing 14a has multiple parts. It includes a handle 18a, by which an operator holds hand tool 10a during operation. Hand tool device 12a includes a tool support unit 20a, a striking mechanism 22a, a first striker arresting device 24a, a second striker arresting device 26a, planetary gearing 28a, a drive unit 30a, an operating device 32a and a torque limiting unit 34a.

Tool support unit 20a includes a tool chuck 36a and a tool spindle 38a. During operation, tool chuck 36a secures an insertion tool not shown here, such as a drill bit or a screw bit. Tool chuck 36 secures the insertion tool in a friction-locked manner. Tool chuck 36a has three chuck jaws, which are movably tightened by an operator and secure the insertion tool during operation. In addition, during operation, tool chuck 36a fixes the insertion tool in position in an axially immovable manner with respect to tool chuck 36a and, in particular, with respect to tool spindle 38a. A portion of tool chuck 36a and tool spindle 38a are interconnected so as to be stationary relative to one another. Here, tool chuck 36a and tool spindle 38a are screwed to one another. Hand tool device 12a has a bearing device 40a, which supports tool spindle 38a on a side facing tool chuck 36a. Bearing device 40a supports tool spindle 38a in an axially movable manner. Bearing device 40a is connected to tool spindle 38a in an axially fixed manner. Bearing device 40a is supported in hand tool housing 14a in an axially movable manner. Hand tool device 12a has a further bearing device 41a, which supports tool spindle 38a on a side facing planetary gearing 28a. In this instance, bearing device 41a takes the form of a rolling-contact bearing, in this case, a needle bearing, through which low-clearance support is possible. Bearing device 41a supports tool spindle 38a in an axially displaceable manner. A striking mechanism spindle 46a surrounds bearing device 41a. Bearing device 41a is functionally situated between tool spindle 38a and striking mechanism spindle 46a.

Tool spindle 38a includes an impact surface 42a, which a striker 44a of striking mechanism 22a strikes during a percussion drill mode. Striker 44a has a mass, which is, at a maximum, two thirds as large as a mass of tool support unit 20a. In this case, the mass of striker 44a is less than half as large as the mass of tool support unit 20a. The mass of striker 44a is approximately 45% of the mass of tool support unit 20a.

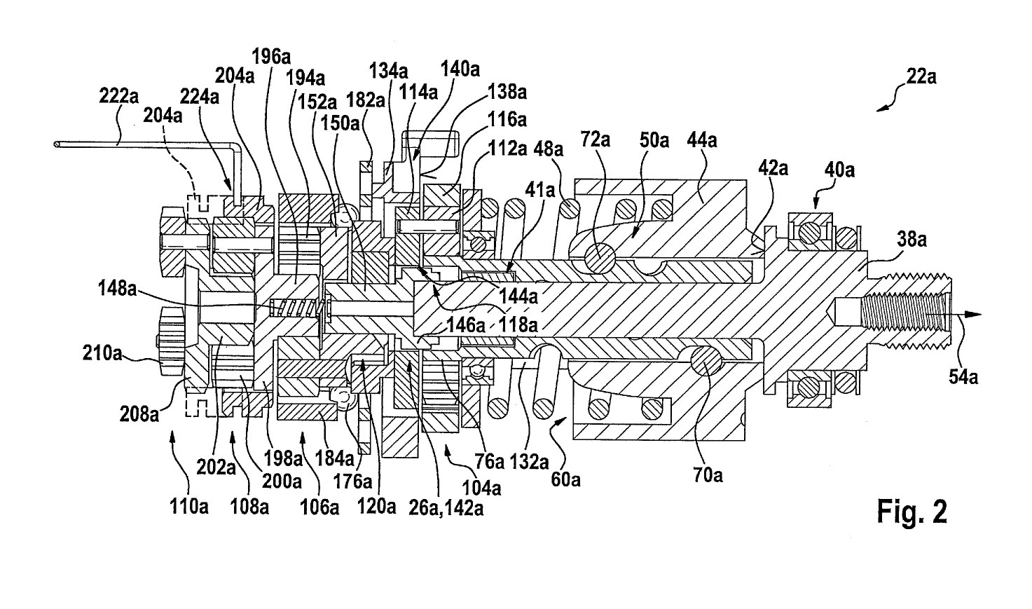

In FIG. 2, striking mechanism 22a and planetary gearing 28a are illustrated in more detail. Striking mechanism 22a includes striker 44a, striking mechanism spindle 46a, a striking mechanism spring 48a, a striker driving device 50a and a striker guide 52a. Striker 44a is supported so as to be translationally movable in striking direction 54a. Striking direction 54a is oriented parallel to an axial direction of striking mechanism spindle 46a.

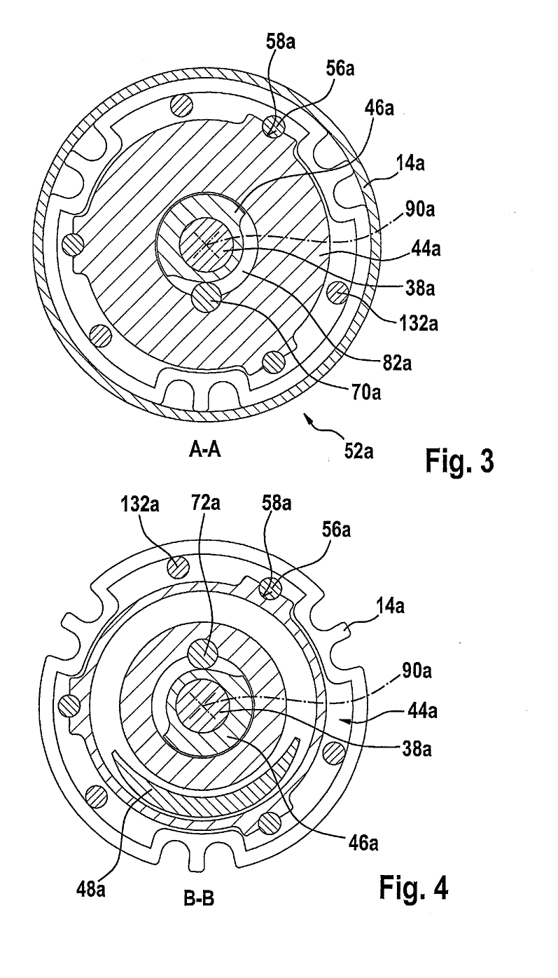

FIGS. 3 and 4 show a sectional plane A and a sectional plane B of striking mechanism 22a. Striker guide 52a supports striker 44a so as to be rotatably fixed relative to hand tool housing 14a. Striker guide 52a has three guide rods 56a, on which striker 44a slides. Guide rods 56a are positioned so as to be evenly spaced about striker 44a. Striker 44a has sliding surfaces 58a, which encircle 180 degrees of the guide rods 56a on a plane perpendicular to striking direction 54a. On a plane that is oriented perpendicularly to striking direction 54a, striker 44a encircles 360 degrees of the striking mechanism spindle 46a. In addition, striker 44a encircles 360 degrees of tool spindle 38a on the plane. Furthermore, striking mechanism spindle 46a encircles 360 degrees of tool spindle 38a on the plane. Striking mechanism spindle 46a and tool spindle 38a are positioned coaxially.

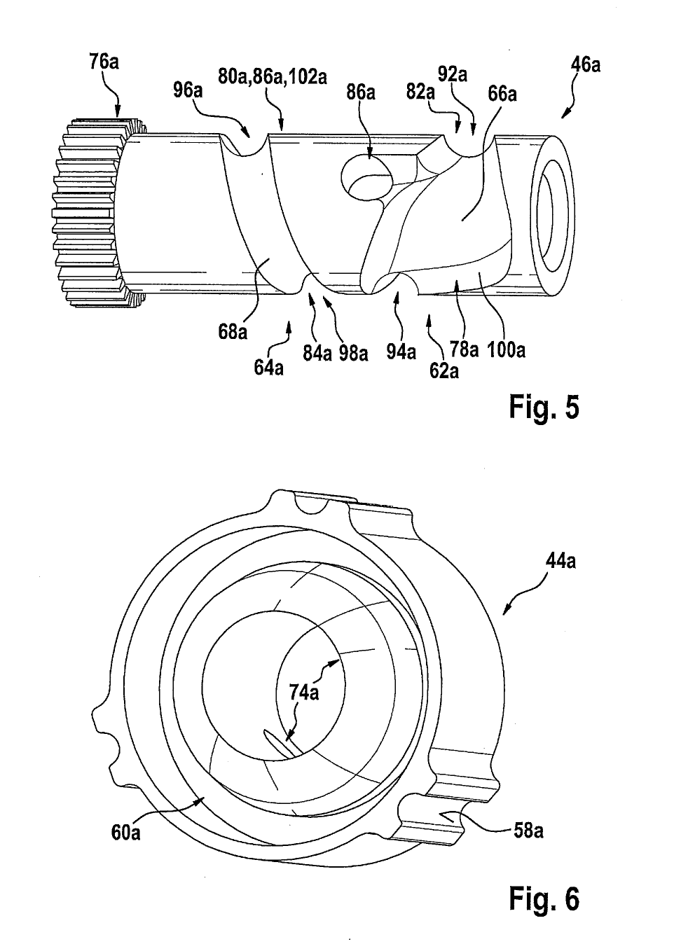

Striking mechanism spring 48a accelerates striker 44a in striking direction 54a prior to an impact. To that end, hand tool housing 14a supports striking mechanism spring 48a on a side facing away from striker 44a. Striking mechanism spring 48a presses directly against striker 44a. Striker 44a has a spring attachment 60a. Spring attachment 60a takes the form of an annular depression. FIG. 5 shows a perspective view of striking mechanism spindle 46a. FIG. 6 shows a perspective view of striker 44a. Striker driving device 50a has a first cam guide 62a and a second first cam guide 64a. Cam guides 62a, 64a include guide curves 66a, 68a and connecting devices 70a, 72a, respectively. Connecting devices 70a, 72a are spherical. Striker 44a supports connecting devices 70a, 72a in a fixed manner relative to striker 44a. Striker 44a includes hemispherical attachment recesses 74a. In a percussion drill mode, connecting devices 70a, 72a slide in guide curves 66a, 68a. Striking mechanism spindle 46a has a part of cam guides 62a, 64a, namely, guide curves 66a, 68a. Striking mechanism spindle 46a delimits a space, in which connecting devices 70a, 72a move during a percussion drill mode.

Striking mechanism spindle 46a takes the form of a hollow shaft. Planetary gearing 28a drives striking mechanism spindle 46a. To that end, striking mechanism spindle 46a has gear teeth 76a on a side facing away from tool chuck 36a.

Guide curves 66a, 68a each have a striker free-running region 78a, 80a, a striker lifting region 82a, 84a, and an assembly opening 86a, 88a. During assembly, connecting devices 70a, 72a are inserted through assembly openings 86a, 88a into attachment recesses 74a of striker 44a. Viewed in striking direction 54a, striking mechanism spindle 46a rotates clockwise during percussion drill mode. Striker lifting regions 82a, 84a are helically shaped. They extend 180 degrees around an axis of rotation 90a of striking mechanism spindle 46a. In percussion drill mode, striker lifting regions 82a, 84a move connecting devices 70a, 72a and, therefore, striker 44a opposite to striking direction 54a. Thus, striking mechanism 22a includes connecting devices 70a, 72a, which transmit a motion of striking mechanism spindle 46a to striker 44a in at least one operating state.

Striker free-running regions 78a, 80a each connect two ends 92a, 94a, 96a, 98a of striker lifting regions 82a, 84a. Striker free-running regions 78a, 80a extend 180 degrees around an axis of rotation 90a of striking mechanism spindle 46a. Striker free-running regions 78a, 80a each have a striking edge 100a, 102a, which, starting from an end 94a, 96a of striker lifting region 82a facing planetary gearing 28a, runs approximately parallel to striking direction 54a. After connecting devices 70a, 72a penetrate into striker free-running regions 78a, 80a, striking mechanism spring 48a accelerates striker 44a and connecting devices 70a, 72a in striking direction 54a. In this context, connecting devices 70a, 72a move through striker free-running regions 78a, 80a without experiencing an axial force, until striker 44a strikes impact surface 42a. Cam guides 62a, 64a are positioned about axis of rotation 90a so as to be offset by 180 degrees. Cam guides 62a, 64a are positioned one behind the other in the axial direction.

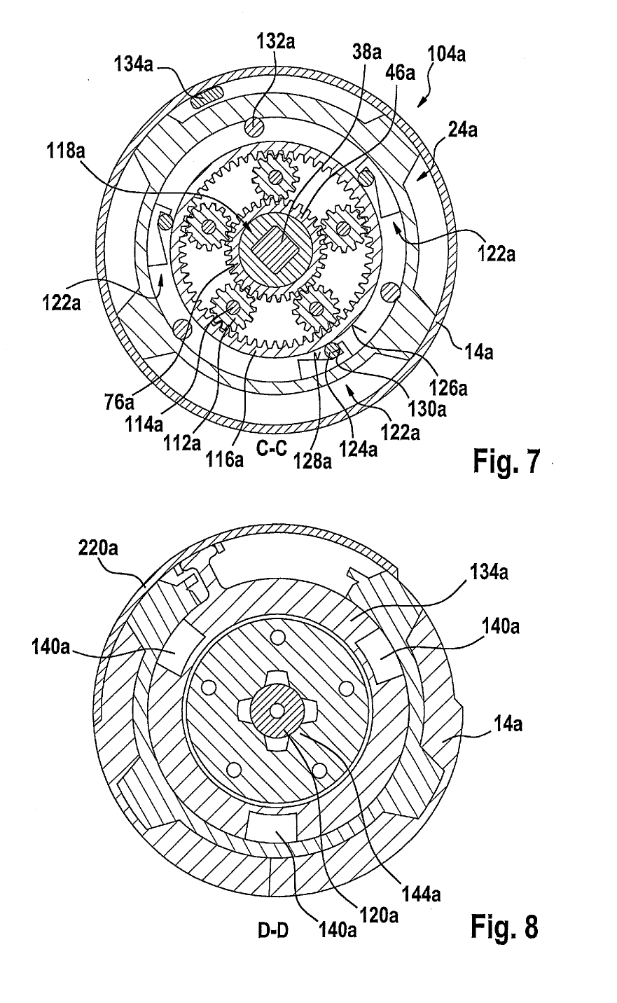

Planetary gearing 28a includes first planetary gear stage 104a, a second planetary gear stage 106a, a third planetary gear stage 108a and a fourth planetary gear stage 110a. FIG. 7 shows a sectional plane C of first planetary gear stage 104a. The planetary gear stages 104a, 106a, 108a, 110a illustrated in FIGS. 7, 12, 13 and 15 include gear wheels having a number of teeth considered suitable by one skilled in the art. The gear wheels of planetary gear stages 104a, 106a, 108a, 110a are in engagement with one another, which, in some instances, is not shown here in this manner. First planetary gear stage 104a increases a first rotational speed of second planetary gear stage 106a for driving striking mechanism 22a. Second planetary gear stage 106a drives tool spindle 38a at this first rotational speed. Gear teeth 76a of striking mechanism spindle 46a form a sun gear of first planetary gear stage 104a. Gear teeth 76a mesh with planet gears 112a of first planetary gear stage 104a, which are supported by a planet carrier 104a of first planetary gear stage. A ring gear 116a of first planetary gear stage 104a meshes with planet gears 112a of first planetary gear stage 104a.

In a percussion drill mode, first striker arresting device 24a fixes ring gear 116a of first planetary gear stage 104a in position relative to hand tool housing 14a. First striker arresting device 24a is configured to engage striker driving device 50a in the case of a first, clockwise drill rotation direction, and to automatically arrest striker driving device 50a in the case of a second, counterclockwise drill rotation direction. First striker arresting device 24a acts upon ring gear 116a of first planetary gear stage 104a.

First striker arresting device 24a locks ring gear 116a of first planetary gear stage 104a in the first, clockwise drill rotation direction. In the case of the second, counterclockwise drill rotation direction, first striker arresting device 24a releases ring gear 116a of first planetary gear stage 104a, so that it may rotate. To that end, first striker arresting device 24a has three locking mechanisms 122a. Locking mechanisms 122a each include a blocking device 124a, a first wedging surface 126a, a second wedging surface 128a and free-running surfaces 130a. Blocking device 124a takes the form of a roller. First wedging surface 126a forms an external region of a surface of ring gear 116a of first planetary gear stage 104a. Second wedging surface 128a is positioned so as to be stationary relative to hand tool housing 14a. During operation in the first, clockwise drill rotation direction, blocking devices 124a become pinched between first wedging surfaces 126a and second wedging surface 128a. During operation in the second, counterclockwise drill rotation direction, free-running surfaces 130a guide blocking devices 124a and prevent locking.

In addition, FIG. 7 shows a connecting device 118a, which connects tool spindle 38a and a planet carrier 120a of second planetary gear stage 106a in a rotatably fixed manner. In this case, connecting device 118a connects tool spindle 38a and planet carrier 120a of second planetary gear stage 106a in an axially displaceable manner.

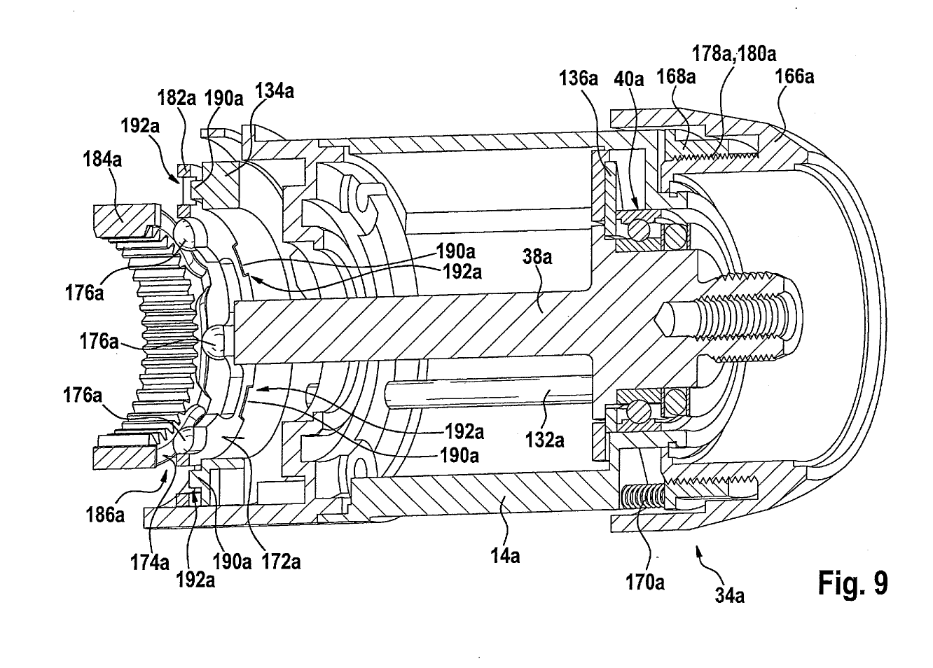

Furthermore, FIGS. 3, 4 and 7 show three first transmission devices 132a of second striker arresting device 26a. Transmission devices 132a take the form of rods. FIG. 8 shows a sectional plane D of a control element 134a of hand tool device 12a. FIG. 9 shows a perspective sectional view of second striker arresting device 26a. In a screwing mode illustrated in FIGS. 1, 8 and 9, as well as in a drilling mode, control element 134a supports tool support unit 20a in a direction opposite to striking direction 54a. A force applied to tool support unit 20a acts upon supporting surfaces 138a of control element 134a via bearing device 40a, a second transmission device 136a of second striker arresting device 26a, and first transmission device 132a. Control element 134a has three recesses 140a. In a percussion drill mode illustrated in FIG. 2, first transmission devices 132a may be pushed into recesses 140a, through which tool support unit 20a is axially moveable.

Second striker arresting device 26a has a striker arresting clutch 142a. Striker arresting clutch 142a is partially formed in one piece with planetary gearing 28a. Striker arresting clutch 142a is situated between first planetary gear stage 104a and second planetary gear stage 106a. Striker arresting clutch 142a has a first coupling element 144a, which is connected to a planet carrier 114a of first planetary gear stage 104a in a rotatably fixed manner. Striker arresting clutch 142a has a second coupling element 146a, which is connected to a planet carrier 120a of second planetary gear stage 106a in a rotatably fixed manner. In the illustrated screwing mode and drilling mode, striker arresting clutch 142a is open. In a percussion drill operation, tool spindle 38a transmits an axial coupling force to striker arresting clutch 142a, when the operator presses an insertion tool against a workpiece. The coupling force closes striker arresting clutch 142a. In FIG. 2, striker arresting clutch 142a is shown closed. When the operator removes the insertion tool from the workpiece, a striker engaging spring 148a of hand tool device 12a opens striker arresting clutch 142a.

Planet carrier 120a of second planetary gear stage 106a is formed in two parts. A first part 150a of planet carrier 120a of second planetary gear stage 106a is connected to tool spindle 38a in a rotatably fixed manner. First part 150a of planet carrier 120a is connected to tool spindle 38a in an axially displaceable manner, which means that even in the event of a stroke, planet carrier 120a remains rotationally coupled to tool spindle 38a. Thus, first part 150a is permanently connected to tool spindle 38a. First part 150a of planet carrier 120a is supported against striker engagement spring 148a in an axially displaceable manner. A second part 152a of planet carrier 120a of second planetary gear stage 106a is connected to first part 150a of planet carrier 120a in a rotatably fixed manner. First part 150a and second part 152a of planet carrier 120a are connected so as to be axially displaceable relative to one another. First part 150a and second part 152a of planet carrier 120a are permanently connected in a rotatably fixed manner.

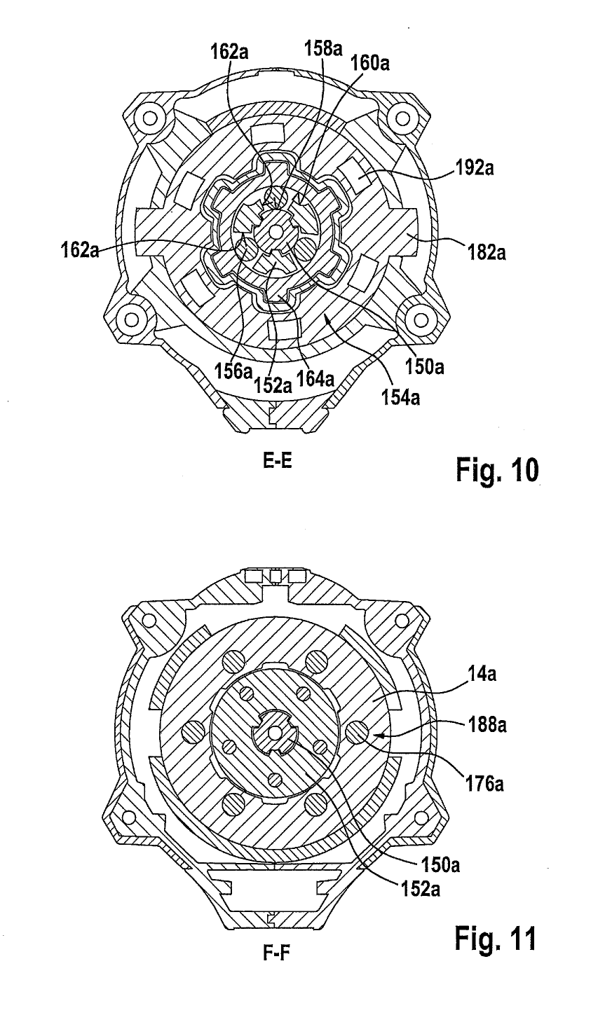

FIG. 10 shows a sectional plane of a spindle locking device 154a of hand tool device 12a. Spindle locking device 154a is provided for connecting tool spindle 38a to hand tool housing 14a in a rotatably fixed manner, when a tool torque is applied to tool chuck 36a, for example, when an insertion tool is clamped in tool chuck 36a. Spindle locking device 154a is partially formed in one piece with planet carrier 120a of second planetary gear stage 106a. Spindle locking device 154a has blocking devices 156a, first wedging surfaces 158a, a second wedging surface 160a and free-running surfaces 162a. Blocking devices 156a are cylindrical. First wedging surfaces 158a take the form of regions of a surface of first part 150a of planet carrier 120a of second planetary gear stage 106a. First wedging surfaces 158a are formed evenly. Second wedging surface 160a is formed as an inner side of a clamping ring 164a of spindle locking device 154a. Clamping ring 164a is connected to hand tool housing 14a in a rotatably fixed manner. Free-running surfaces 162a are formed as regions of a surface of second part 152a of planet carrier 120a of second planetary gear stage 106a. When a tool torque is applied to tool chuck 36a, blocking devices 156a become wedged between first wedging surfaces 158a and second wedging surface 160a. When drive unit 30a operates, free-running surfaces 162a lead blocking devices 156a on a circular path and prevent jamming. First part 150a and second part 152a of planet carrier 120a are engaged with one another with play.

FIGS. 1, 2, 9 and 10 show torque limiting unit 34a. Torque limiting unit 34a is designed to limit a maximum tool torque outputted by tool chuck 36a in a screwing mode. Torque limiting unit 34a includes an operating element 166a, an adjusting element 168a, limiting springs 170a, transmission devices not shown in further detail, first stop faces 172a, a second stop face 174a and limiting devices 176a. Operating element 166a is annular. It follows tool chuck 36a in the direction of planetary gearing 28a. Operating element 166a includes a setting thread 178a, which is coupled to a setting thread 180a of adjusting element 168a. Adjusting element 168a is supported in a rotatably fixed and axially displaceable manner. When operating element 166a is rotated, adjusting element 168a is displaced in the axial direction. On one side, limiting springs 170a are supported at adjusting element 168a. On another side, limiting springs 170a are supported at a limit stop device 182a of torque limiting unit 34a, via the transmission devices. A surface of limit stop device 182a includes first stop faces 172a. In the screwing mode, limit stop device 182a is movably supported in opposition to limiting springs 170a in the axial direction. Second stop face 174a takes the form of a region of a surface of a ring gear 184a of second planetary gear stage 106a. Second stop face 174a has trough-shaped depressions 186a. Limiting devices 176a are formed in the shape of spheres. Limiting devices 176a are supported in tubular channels 188a so as to be displaceable in striking direction 54a. FIG. 11 shows a sectional plane F of torque limiting unit 34a. In a screwing operation, limiting devices 176a are situated in trough-shaped depressions 186a. In this instance, limiting devices 176a secure ring gear 184a of second planetary gear stage 106a in a rotatably fixed manner. In response to the set, maximum tool torque being reached, limiting devices 176a push limit stop device 182a away, against limiting springs 170a. Then, limiting devices 176a each spring into the nearest of the trough-shaped depressions 186a. In the process, ring gear 184a of second planetary gear stage 106a rotates, thereby interrupting the screwing operation.

Control element 134a of hand tool device 12a has support devices 190a, which prevent an axial movement of limit stop device 182a in at least a drilling mode. To that end, support devices 190a brace limit stop device 182a in the axial direction. In the case of a screwing mode illustrated, in particular, in FIG. 9, limit stop device 182a has screw openings 192a, into which limit stop devices 182a enter when the maximum tool torque is reached. In the case of a screwing setting of control element 134a, the support devices 190a are correspondingly positioned. In a percussion drill mode, support devices 190a also prevent an axial movement of limit stop device 182a and, therefore, a response of torque limiting unit 34a. As an alternative, in a percussion drill mode, limit stop devices could also be positioned in such a manner, that they are able to enter into screw openings. Consequently, a torque limiting unit would be active in percussion drill mode.

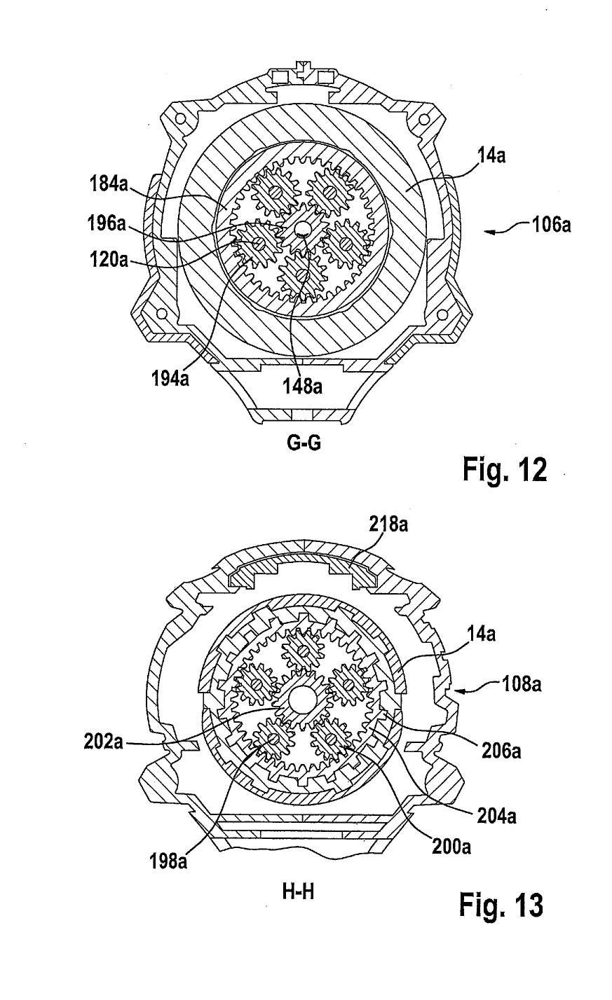

FIG. 12 shows a sectional plane G of second planetary gear stage 106a. In at least a drilling mode, ring gear 184a of second planetary gear stage 106a is supported in hand tool housing 14a so as to be protected against complete rotation.

Planet gears 194a of second planetary gear stage 106a mesh with ring gear 184a and a sun gear 196a of second planetary gear stage 106a.

FIG. 13 shows a sectional plane H of third planetary gear stage 108a. Sun gear 196a of second planetary gear stage 106a is connected to a planet carrier 198a of third planetary gear stage 108a in a rotatably fixed manner. Planet gears 200a of third planetary gear stage 108a mesh with a sun gear 202a and a ring gear 204a of third planetary gear stage 108a. Ring gear 204a of third planetary gear stage 108a has toothing 206a, which, in a first gear ratio, connects ring gear 204a of third planetary gear stage 108a to hand tool housing 14a in a rotatably fixed manner.

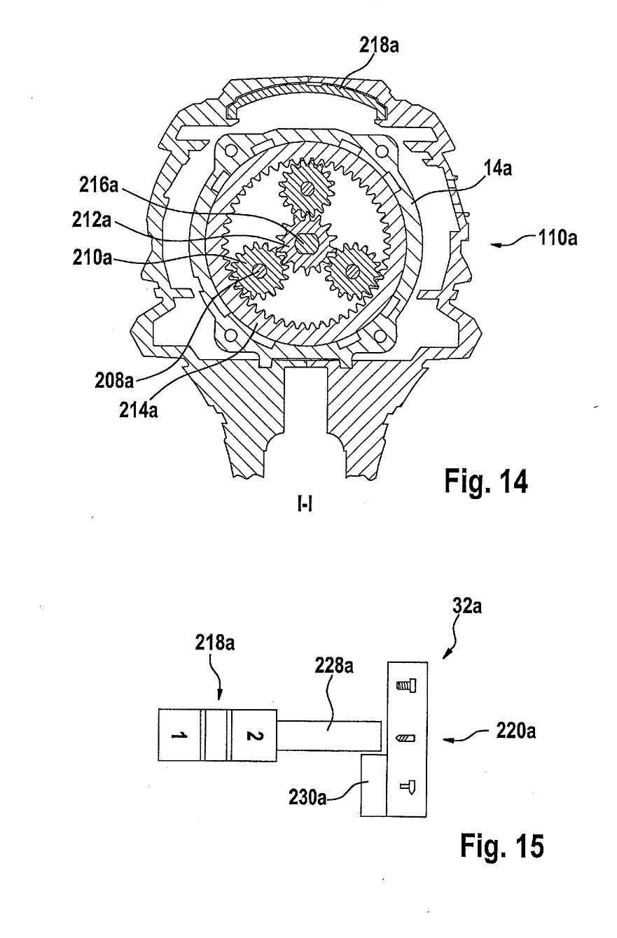

FIG. 14 shows a sectional plane I of third planetary gear stage 108a. Sun gear 202a of third planetary gear stage 108a is connected to a planet carrier 208a of fourth planetary gear stage 110a in a rotatably fixed manner. Planet gears 210a of fourth planetary gear stage 110a mesh with a sun gear 212a and a ring gear 214a of fourth planetary gear stage 110a. Ring gear 214a is connected to hand tool housing 14a in a rotatably fixed manner. Sun gear 212a of fourth planetary gear stage 110a is connected to a rotor 216a of drive unit 30a in a rotatably fixed manner.

As shown in FIG. 2, ring gear 204a of third planetary gear stage 108a is supported so as to be displaceable in the axial direction. In the first gear ratio, ring gear 204a of third planetary gear stage 108a is connected to hand tool housing 14a in a rotatably fixed manner. In the second gear ratio, ring gear 204a of third planetary gear stage 108a is connected to planet carrier 208a of fourth planetary gear stage 110a in a rotatably fixed manner, and is supported so as to be rotatable relative to hand tool housing 14a. This produces a reduction ratio of the first gear ratio between rotor 216a of drive unit 30a and planet carrier 198a of third planetary gear stage 108a, which is greater than a reduction ratio of the second gear ratio.

Operating device 32a has a first operating element 218a and a second operating element 220a. First operating element 218a is situated on a side of hand tool housing 14a facing away from handle 18a. It is supported so as to be movable parallelly to the axial direction of planetary gearing 28a. First operating element 218a is connected to ring gear 204a of third planetary gear stage 108a in the axial direction by an adjusting device 222a of operating device 32a. Ring gear 204a of third planetary gear stage 108a has a keyway 224, with which adjusting device 222a engages. Consequently, ring gear 204a of third planetary gear stage 108a is connected to adjusting device 222a in the axial direction, so as to be axially rotatable relative to adjusting device 222a. Adjusting device 222a is designed to be elastic, which means that the gear ratio may be adjusted independently of a rotational position of ring gear 204a of third planetary gear stage 108a. When first operating element 218a is pushed in the direction of tool chuck 36a, the first gear ratio is set. When second operating element 220a is pushed away from tool chuck 36a, the second gear ratio is set.

Second operating element 220a is situated on a side of hand tool housing 14a facing away from handle 18a. Second operating element 220a is positioned so as to be displaceable about an axis, which is oriented parallel to the axial direction of planetary gearing 28a. Second operating element 220a is connected to control element 134a of hand tool device 12a in a rotatably fixed manner. The screwing mode, the drilling mode and the percussion drill mode may be set, using second operating element 220a. When second operating element 220a is pushed to the left, as viewed in striking direction 54a, the percussion drill mode is set. When second operating element 220a is pushed to the right, as viewed in striking direction 54a, the screwing mode is set. When second operating element 220a is positioned centrally, as viewed in striking direction 54a, the drilling mode is set.

FIG. 15 schematically illustrates a safety device 226a of hand tool device 12a, which prevents operation in the percussion drill mode at the first gear ratio. In FIG. 15, the first gear ratio and the drilling mode are set. Safety device 226a is partially formed in one piece with operating device 32a. A first blocking device 228a of safety device 226a is formed on first operating element 218a. A second blocking device 230a of safety device 226a is formed on second operating element 220a. Blocking devices 228a are each tongue-shaped. First blocking device 228a extends in the direction of second operating element 220a. Second blocking device 230a extends in the direction of first operating element 218a. Safety device 226a prevents a switchover into the percussion drill mode, when the first gear ratio is set. Safety device 226a prevents a switchover into the first gear ratio, when the percussion drill mode is set.

Drive unit 30a takes the form of an electric motor. Drive unit 30a has a maximum torque, which produces a maximum tool torque of greater than 15 Nm at the first gear ratio, and less than 15 Nm at the second gear ratio. The maximum tool torque at the first gear ratio is 30 Nm. The maximum tool torque at the second gear ratio is 10 Nm. In this context, the tool torque is to be determined according to the DIN EN 60745 standard.

In a percussion drill mode, striker engagement spring 148a of hand tool device 12a opens striker arresting clutch 142a when the operator removes the insertion tool from the workpiece. Striker engagement spring 148a is positioned coaxially to planetary gear stages 104a, 106a, 108a, 110a of planetary gearing 28a. Second planetary gear stage 106a and third planetary gear stage 108a each surround striker engagement spring 148a on at least one plane, which is oriented perpendicularly to the axial direction of planetary gearing 28a. Second planetary gear stage 106a and third planetary gear stage 108a are each positioned functionally between at least two further planetary gear stages 104a, 106a, 108a, 110a of planetary gearing 28a. Planet carrier 120a of second planetary gear stage 106a supports striker engagement spring 148a on a side facing away from tool chuck 36a.

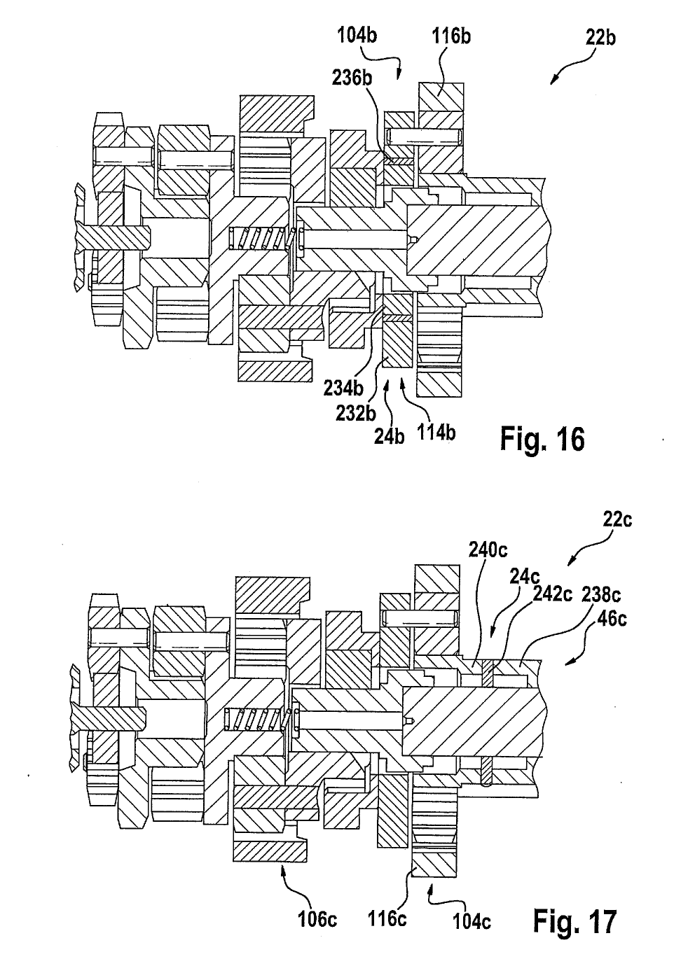

Further exemplary embodiments of the present invention are shown in FIGS. 16 through 19. The following descriptions and the drawings are mainly limited to the differences between the exemplary embodiments. With regard to identically labeled components, in particular, with regard to components having the same reference characters, in general, reference may also be made to the drawings and/or the description of the other exemplary embodiments, in particular, of FIGS. 1 through 15. To distinguish between the exemplary embodiments, the letter “a” follows the reference numerals of the exemplary embodiment in FIGS. 1 through 15. In the exemplary embodiments of FIGS. 16 through 19, the letter “a” is replaced by the letters “b” through “e.”

A further, alternative exemplary embodiment of a first striker arresting device 24b is schematically illustrated in FIG. 16. A planet carrier 114b of a first planetary gear stage 104b is formed in two parts. A first part 232b of planet carrier 114b supports planet gears 112b of first planetary gear stage 104b. A second part 234b of planet carrier 114b is rotationally coupled to a second planetary gear stage 106b. A first striker arresting device 24b of a striking mechanism 22b has an overrunning clutch 236b, which is considered to be suitable by one skilled in the art, connects first part 232b and second part 234b of planet carrier 114b in a rotatably fixed manner in the case of a clockwise drill rotation direction, and separates them in the case of a counterclockwise drill rotation direction. A ring gear 116 of first planetary gear stage 104b is permanently connected to a hand tool housing in a rotatably fixed manner.

A further exemplary embodiment of a first striker arresting device 24c is schematically illustrated in FIG. 17. A striking mechanism spindle 46c of a striking mechanism 22c is formed in two parts. A first part 238c of striking mechanism spindle 46c is connected to a striker driving device. A second part 240c of striking mechanism spindle 46c is connected to a second planetary gear stage 106c. First striker arresting device 24c has an overrunning clutch 242c, which is considered suitable by one skilled in the art, connects first part 238b and second part 240c of striking mechanism spindle 46c in a rotatably fixed manner in the case of a clockwise drill rotation direction, and separates them in the case of a counterclockwise drill rotation direction. A ring gear 116c of first planetary gear stage 104c is permanently connected to a hand tool housing in a rotatably fixed manner.

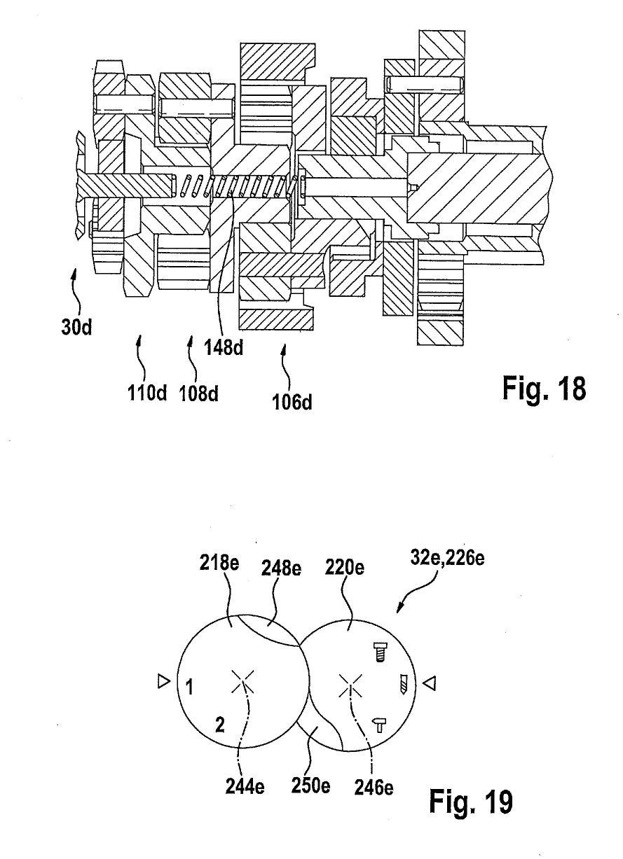

A further exemplary embodiment of a striker engagement spring 148d is illustrated in FIG. 18. A second planetary gear stage 106d supports striker engagement spring 148d on a side facing a tool chuck. A drive unit 30d supports striker engagement spring 148d on a side facing away from a tool chuck. Second planetary gear stage 106d, a third planetary gear stage 108d and a fourth planetary gear stage 110d each surround striker engagement spring 148d on at least one plane, which is oriented perpendicularly to an axial direction of planetary gear stages 106d, 108d, 110d. Drive unit 30d is connected to a part of planetary gear stage 110d in a rotatably fixed manner.

FIG. 19 shows an alternative exemplary embodiment of operating device 32e and of a safety device 226e. Operating device 32e has a first operating element 218e and a second operating element 220e. Operating elements 218e, 220e are pivoted about axes of rotation 244e, 246e. Operating elements 218e, 220e are basically disk-shaped. First operating element 218e is connected to planetary gearing in a manner not shown in further detail, using a mechanism considered suitable by one skilled in the art. A first gear ratio and a second gear ratio may be set with the aid of first operating element 218e. Second operating element 220e is connected to a control element in a manner not shown in further detail, using a mechanism considered suitable by one skilled in the art. A screwing mode, a drilling mode and a percussion drill mode may be set with the aid of second operating element 220e. In addition, a chipping mode could be set.

Safety device 226e has a free-running region 248e delimited by first operating element 218e. Safety device 226e has a free-running region 250e delimited by second operating element 220e. Free-running region 248e of first operating element 218e allows the screwing mode, the drilling mode and the percussion drill mode to be set, when a second gear ratio is set. Free-running region 250e of second operating element 220e allows the screwing mode and the drilling mode to be set, when a first gear ratio is set. In the percussion drill mode, safety device 226e prevents the first gear ratio from being set. When the first gear ratio is set, safety device 226e prevents the percussion drill mode from being set.

What is claimed is:

1. A hand tool device, comprising:
a striking mechanism which has a striker, a striker driving device, and a striker arresting device;
wherein in the case of a first drill rotation direction, the striker driving device is configured to propel the striker in at least a striking direction; and
the striker arresting device is configured to prevent the striker driving device from being operated in the case of a second drill rotation direction.

2. The hand tool device as recited in claim 1, further comprising:
a planetary gear stage which operates the striker driving device in at least one operating state.

3. The hand tool device as recited in claim 2, wherein the striker arresting device acts upon a ring gear of the planetary gear stage.

4. The hand tool device as recited in claim 2, wherein the striker arresting device acts upon a planet carrier of the planetary gear stage.

5. The hand tool device as recited in claim 2, wherein the striker arresting device acts upon a striking mechanism spindle of the striking mechanism.

6. The hand tool device as recited in claim 2, wherein the striker arresting device is configured to automatically prevent the striker driving device from being operated in the case of a counterclockwise drill rotation direction.

7. The hand tool device as recited in claim 2, wherein the striker arresting device is configured to stop the striker driving device in the case of a second drill rotation direction.

8. The hand tool device as recited in claim 2, wherein the striker arresting device includes a blocking device which allows free-running in at least one operating state.

9. The hand tool device as recited in claim 2, wherein the striker driving device includes a cam guide which drives the striker in at least a percussion drill mode.

10. The hand tool device as recited in claim 9, wherein the cam guide includes a striker free-running region.
